(19) United States
(12) Patent Application Publication
(10) Pub. No.: US 2021/0098012 A1
(43) Pub. Date: Apr. 1, 2021

(54) Voice Skill Recommendation Method, Apparatus, Device and Storage Medium

(71) Applicant: Baidu Online Network Technology (Beijing) Co., Ltd., Beijing (CN)

(72) Inventor: Yaowen QI, Beijing (CN)

(73) Assignee: Baidu Online Network Technology (Beijing) Co., Ltd., Beijing (CN)

(21) Appl. No.: 16/935,298

(22) Filed: Jul. 22, 2020

(30) Foreign Application Priority Data
Sep. 27, 2019 (CN) 201910926816.X

(51) Int. Cl. G10L 21/003; G10L 25/54; G06F 16/9032

(52) U.S. Cl. CPC G10L 21/003; G06F 16/90324; G10L 25/54

(57) ABSTRACT

The present application discloses a voice skill recommendation method, apparatus, device, and storage medium, and relates to the field of voice technology. A specific implementation solution is: acquiring a voice command of a user, where the voice command includes an acquisition condition of a voice skill; acquiring, according to the acquisition condition, a second voice skill related to a first voice skill; where the first voice skill is a currently used voice skill or the voice skill contained in the voice command; recommending the second voice skill to the user. Embodiments of the present application can realize an accurate associated recommendation of the voice skill, thereby enhancing user experience, and improving a promotion effect of the voice skill at the same time.

### CROSS-REFERENCE TO RELATED APPLICATION

This application claims priority to Chinese Patent Application No. 201910926816.X, filed on Sep. 27, 2019, which is hereby incorporated by reference in its entirety.

### TECHNICAL FIELD

The present application relates to computer technology, and in particular, to the field of voice technology.

### BACKGROUND

With the development of artificial intelligence technology, intelligent voice devices such as smart speakers are becoming more and more popular. The voice skill, as the basic function of the smart speakers, can provide the user with conversational interactive services, that is, provide the user with a function or a service through the voice, such as checking the weather, listening to music, voice games, and the user can complete the interaction only by the voice.

As more and more voice skills are developed, it becomes more difficult for the user to find a voice skill; especially, some intelligent voice devices are not equipped with a display screen. Limited by voice interaction, the user cannot quickly and accurately acquire the voice skill they are interested in.

### SUMMARY

The present application provides a voice skill recommendation method, apparatus, device and storage medium, so as to realize an accurate associated recommendation of a voice skill, thereby enhancing user experience, and improving a promotion effect of the voice skill at the same time.

A first aspect of the present application provides a voice skill recommendation method, including:

acquiring a voice command of a user, where the voice command includes an acquisition condition of a voice skill;

acquiring, according to the acquisition condition, a second voice skill related to a first voice skill; where the first voice skill is a currently used voice skill or the voice skill contained in the voice command;

recommending the second voice skill to the user.

The above method can realize the accurate associated recommendation of the voice skill, thereby enhancing the user experience, and improving the promotion effect of the voice skill at the same time.

In an embodiment, the acquisition condition is to acquire a voice skill of the same type;

the acquiring, according to the acquisition condition, a second voice skill related to a first voice skill, includes:

acquiring type information of the first voice skill; and

acquiring, according to the acquisition condition, the second voice skill that has the same type information as that of the first voice skill.

The above method can realize associated recommendation for the voice skill of the same type.

In an embodiment, the acquisition condition is to acquire a voice skill having the same developer;

the acquiring, according to the acquisition condition, a second voice skill related to a first voice skill, includes:

acquiring developer information of the first voice skill; and

acquiring, according to the acquisition condition, the second voice skill that has the same developer information as that of the first voice skill.

The above method can realize associated recommendation for the voice skill having the same developer.

Further, the recommending the second voice skill to the user, includes:

acquiring user preference information when there are at least two second voice skills; and

determining, according to the user preference information, a target second voice skill from the at least two second voice skills, and recommending the target second voice skill to the user.

The above method can realize associated recommendation of the voice skill according to the user preference, thereby meeting personalized requirements of the user and enhancing the user experience.

Further, the acquiring user preference information, includes:

acquiring, according to a historical behavior log of the user acquired in advance, the user preference information.

Further, the recommending the second voice skill to the user, includes:

generating, according to the second voice skill, voice recommendation information, and playing the voice recommendation information; and

enabling the second voice skill after receiving a start command for the second voice skill from the user.

Further, the method further includes:

displaying the second voice skill on a display unit; and

receiving a selection operation command of the user for the second voice skill on the display unit, and enabling the second voice skill according to the selection operation command.

The above method is convenient for visual recommendation display of the voice skill and can better show the second voice skill to the user, which makes it easier for the user to select therefrom.

A second aspect of the present application provides a voice skill recommendation apparatus, including:

an acquiring module, configured to acquire a voice command of a user, where the voice command includes an acquisition condition of a voice skill;

a processing module, configured to acquire, according to the acquisition condition, a second voice skill related to a first voice skill; where the first voice skill is a currently used voice skill or the voice skill contained in the voice command; and

a recommending module, configured to recommend the second voice skill to the user.

A third aspect of the present application provides an electronic device, including:

at least one processor; and

a memory communicatively connected to the at least one processor; where

the memory stores instructions executable by the at least one processor, and the instructions are executed by the at least one processor to cause the at least one processor to execute the method according to the first aspect.

A fourth aspect of the present application provides a non-transitory computer-readable storage medium having stored thereon computer instructions, where the computer instructions are configured to cause the computer to execute the method according to the first aspect.

A fifth aspect of the present application provides a computer program including program codes, when a computer runs the computer program, the program codes execute the method according to the first aspect.

A sixth aspect of the present application provides a voice skill recommendation method, including:

acquiring an acquisition command for a voice skill of a user;

acquiring, according to the acquisition command for the voice skill, a target voice skill; and

recommending the target voice skill to the user.

An embodiment of the above application has the following advantages or beneficial effects: by acquiring a voice command of a user, where the voice command includes an acquisition condition of a voice skill; acquiring, according to the acquisition condition, a second voice skill related to a first voice skill; where the first voice skill is a currently used voice skill or the voice skill contained in the voice command; recommending the second voice skill to the user, embodiments of the present application can realize the accurate associated recommendation of the voice skill, thereby enhancing the user experience, and improving the promotion effect of the voice skill at the same time.

Other effects of the above implementations will be illustrated below with reference to specific embodiments.

### BRIEF DESCRIPTION OF THE DRAWINGS

The accompanying drawings are for a better understanding of the solution, and do not constitute a limitation on the present application, where

FIG. 1 is a flowchart of a voice skill recommendation method according to an embodiment of the present application;

FIG. 2 is a scenario diagram of a voice skill recommendation method according to an embodiment of the present application;

FIG. 3 is a flowchart of a voice skill recommendation method according to another embodiment of the present application;

FIG. 4 is a flowchart of a voice skill recommendation method according to another embodiment of the present application;

FIG. 5 is a flowchart of a voice skill recommendation method according to another embodiment of the present application;

FIG. 6 is a block diagram of a voice skill recommendation apparatus according to an embodiment of the present application;

FIG. 7 is a block diagram of an electronic device for implementing a voice skill recommendation method according to an embodiment of the present application.

### DESCRIPTION OF EMBODIMENTS

The exemplary embodiments of the present application are illustrated below in conjunction with the accompanying drawings, various details of the embodiments of the present application are contained for ease of understanding, and the embodiments should be considered as merely exemplary. Therefore, those of ordinary skill in the art should recognize that various changes and modifications to the embodiments described herein can be made without departing from the scope and spirit of the application. Also, for the sake of clarity and conciseness, descriptions of well-known functions and structures are omitted in the following description.

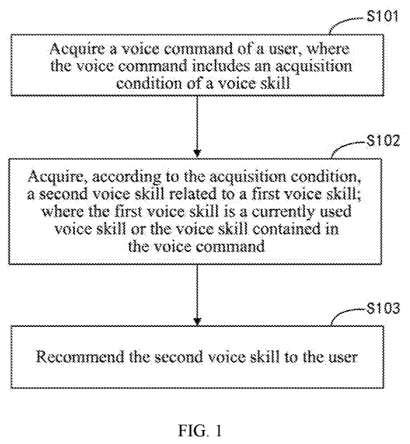

An embodiment of the present application provides a voice skill recommendation method, and FIG. 1 is a flowchart of a voice skill recommendation method according to an embodiment of the present disclosure. The execution subject may be an intelligent voice device, such as a smart speaker. As shown in FIG. 1, specific steps of the voice skill recommendation method are as follows:

S101, acquire a voice command of a user, where the voice command includes an acquisition condition of a voice skill.

In this embodiment, when the user gives the voice command, the intelligent voice device can collect the voice command of the user; for example, when the user gives a voice command such as “obtain a voice skill of the same type” or “obtain a voice skill having the same developer”, the intelligent voice device can collect the voice command of the user through a sound collection apparatus such as a microphone, where the voice command contain the acquisition condition of the voice skills, that is, “the same kind” and “the same developer” are a limited condition for a desired voice skill given by the user.

S102, acquire, according to the acquisition condition, a second voice skill related to a first voice skill; where the first voice skill is a currently used voice skill or the voice skill contained in the voice command.

In the embodiment, after performing voice recognition on the voice command of the user, the acquisition condition of the voice skill contained therein can be acquired, and then the voice skill can be recommended according to the acquisition condition. Specifically, in case that the user is currently using a first voice skill, or the user is using a voice skill store, and it is specified in the voice command to acquire the voice skill that is related to the first voice skill and satisfies the acquisition condition (for example, of the same type or having the same developer). At this time, the second voice skill may be acquired from the voice skill store (i.e., a voice skill database) according to the acquisition condition and a related attribute of the first voice skill, and the second voice skill is related to the first voice skill and satisfies the acquisition condition.

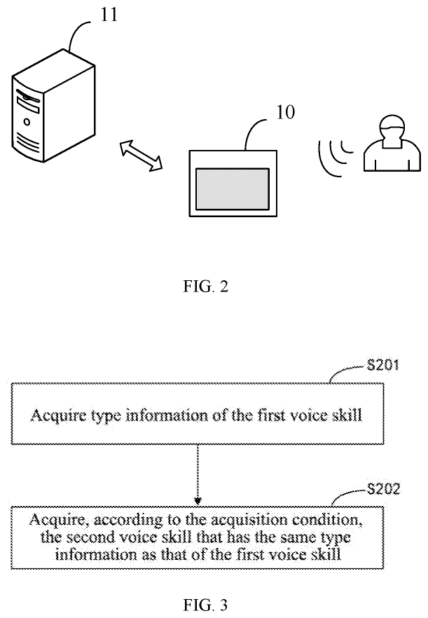

It should be noted that the voice skill database in the embodiment may be provide in a local area of the intelligent voice device, the intelligent voice device may directly obtain the second voice skill from a local voice skill database; of course, the voice skill recommendation method of the embodiment can also be applied to the system shown in FIG. 2, where an intelligent voice device 10 is communicatively connected to a server 11. A voice skill database may be set in the server 11. The intelligent voice device 10 may transmit the acquisition condition and information of the first voice skill to the server 11, or directly transmit the voice command of the user to the server 11. The server 11 acquires the second voice skill from the voice skill database and then returns it to the intelligent voice device 10.

S103, recommend the second voice skill to the user.

In the embodiment, after the second voice skill is acquired, the second voice skill can be recommended to the user. In an embodiment, voice recommendation information may be generated through a preset verbal trick or some personalized verbal tricks according to the second voice skill, and the voice recommendation information can be played, thereby recommending the second voice skill to the user, such as the following dialogue example:

Background: the user is currently using the first voice skill (such as a game-type voice skill);

User: what other voice skills of the same type are there?

Intelligent voice device: a voice skill of the same type further includes “electronic pet” (skill name), which is a large-scale voice game skill for developing adventure (skill brief description), shall I open it for you?

User: Yes.

Intelligent voice device: OK, now the voice skill “electronic pet” is opened for you.

In the embodiment, the generating voice recommendation information according to the second voice skill may specifically include, but is not limited to, the name, brief description, guide, or the like of the second voice skill, and may also ask whether to start, or may include other personalized verbal tricks, which will not repeated herein. After the voice recommendation information is played, and the user's start command for the second voice skill is received thereafter, the second voice skill is started. Of course, if the user refuses to start, a recommendation of the second voice skill can be performed again.

In another embodiment, if the intelligent voice device is equipped with a display unit (such as a display screen, a projector), the second voice skill can be displayed in the display unit, which is convenient for visual recommendation display for the second voice skill and can better show the second voice skill to the user when there are multiple second voice skills, which makes it easier for the user to select therefrom. In an embodiment, the recommended second voice skill may pop up from the bottom of the display unit, and the user may select a second voice skill for activation by clicking or voice command. In addition, the user may also swipe left or right to view more voice skills.

A voice skill recommendation method according to this embodiment, by acquiring a voice command of a user, where the voice command includes an acquisition condition of a voice skill; acquiring, according to the acquisition condition, a second voice skill related to a first voice skill; where the first voice skill is a currently used voice skill or the voice skill contained in the voice command; recommending the second voice skill to the user; can realize an accurate associated recommendation of a voice skill, thereby enhancing user experience, and improving a promotion effect of the voice skill at the same time.

On the basis of the above embodiments, in an embodiment, the acquiring condition is to acquire a voice skill of the same type. Further, as shown in FIG. 3, the acquiring, according to the acquisition condition, a second voice skill related to a first voice skill in S102 includes:

S201, acquire type information of the first voice skill; and

S202, acquire, according to the acquisition condition, the second voice skill that has the same type information as that of the first voice skill.

In the embodiment, when the voice command of the user is to acquire the voice skill of the same type, if the voice command does not involve the first voice skill, the currently used voice skill is used as the first voice skill, and then the type information of the currently used voice skill can be acquired; if the voice command involves the first voice skill, the type information of the first voice skill is acquired. The type information is, for example, a voice call, a home appliance control, a games, or the like. After the type information of the first voice skill is acquired, the voice skill of the same type is queried from the voice skill database serving as the second voice skill to be recommended to the user.

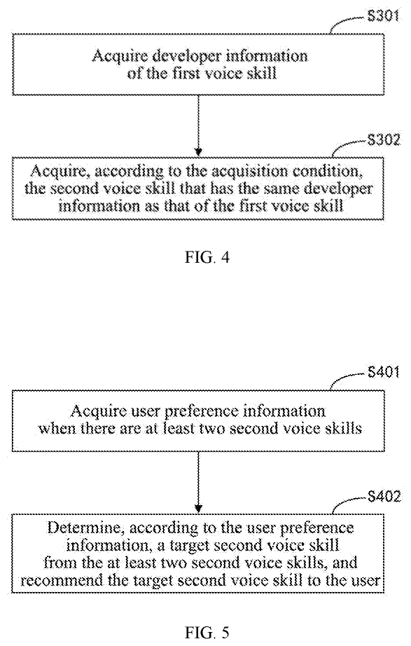

On the basis of the above embodiments, in another embodiment, the acquiring condition is to acquire a voice skill having the same developer. Further, as shown in FIG. 4, the acquiring, according to the acquisition condition, a second voice skill related to a first voice skill in S102 includes:

S301, acquiring developer information of the first voice skill; and

S302, acquiring, according to the acquisition condition, the second voice skill that has the same developer information as that of the first voice skill.

In the embodiment, when the voice command of the user is to acquire the voice skill having the same developer, similarly, if the voice command does not involve the first voice skill, the currently used voice skill is used as the first voice skill, and then the developer information of the currently used voice skill can be acquired; if the voice command involves the first voice skill, the developer information of the first voice skill is acquired. After the developer information of the first voice skill is acquired, the voice skill having the same developer information is queried from the voice skill database serving as the second voice skill to be recommended to the user, such as the following dialogue example:

Background: the user is currently using the voice skill store;

User: what other voice skills have the developer of the electronic pet developed?

Intelligent voice device: the developer is Developer A. He has also developed the voice skill “Fighting Hero” (skill name), a voice fighting game (skill brief description), shall I open it for you?

User: Yes.

Intelligent voice device: OK, now the voice skill “Fighting Hero” is opened for you.

In any of the above embodiments, as shown in FIG. 5, the recommending the second voice skill to the user in S103 specifically includes:

S401, acquire user preference information when there are at least two second voice skills; and

S402, determine, according to the user preference information, a target second voice skill from the at least two second voice skills, and recommend the target second voice skill to the user.

In the embodiment, there may be at least two second voice skills in the process of acquiring the second voice skill, and it is impossible for the intelligent voice device to recommend all the second voice skills to the user, so it is necessary to select at least one target second voice skill from the least two second voice skills and recommend it to the user. Therefore, in the embodiment, the user preference information is acquired, and the at least two second voice skills are filtered according to the user preference information, and the target second voice skill is determined and recommended to the user, thereby satisfying personalized requirements of the user and enhancing user experience. The user preference information can be acquired by acquiring a historical behavior log of the user in advance, analyzing the historical behavior log of the user and summarizing a preference of the user for voice skills, such as the following dialogue example:

Background: the user is currently using the first voice skill (such as a game-type voice skill);

User: what other voice skills of the same type are there?

Intelligent voice device: Smart me know that you like action-based voice skills (user preference information), a voice skill of the same type further includes “electronic pet” (skill name), which is a large-scale voice game skill for developing adventure (skill brief description), shall I open it for you?

User: Yes.

Intelligent voice device: OK, now the voice skill “electronic pet” is opened for you.

In the above examples, when the first voice skill is a game-based voice skill and there are at least two game-based voice skills (that is, there are at least two second voice skills), after the user preference information is determined, an action-based voice skill preferred by the user can be selected from multiple game-based voice skills for recommendation.

A voice skill recommendation method according to the above embodiment, by acquiring a voice command of a user, where the voice command includes an acquisition condition of a voice skill; acquiring, according to the acquisition condition, a second voice skill related to a first voice skill; where the first voice skill is a currently used voice skill or the voice skill contained in the voice command; recommending the second voice skill to the user, can realize an accurate associated recommendation of a voice skills, thereby enhancing user experience, and improving a promotion effect of the voice skill at the same time.

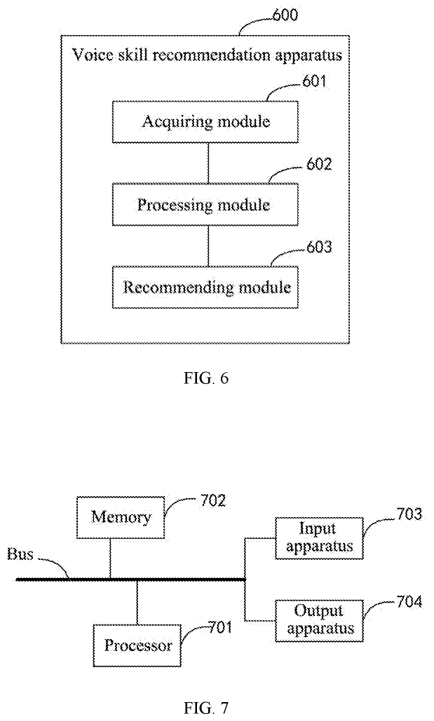

An embodiment of the present application provides a voice skill recommendation apparatus, and FIG. 6 is a block diagram of a voice skill recommendation apparatus according to an embodiment of the present disclosure. As shown in FIG. 6, the voice skill recommendation apparatus 600 specifically includes: an acquiring module 601, a processing module 602, and a recommending module 603.

The acquiring module 601 is configured to acquire a voice command of a user, where the voice command includes an acquisition condition of a voice skill;

the processing module 602 is configured to acquire, according to the acquisition condition, a second voice skill related to a first voice skill; where the first voice skill is a currently used voice skill or the voice skill contained in the voice command; and

the recommending module 603 is configured to recommend the second voice skill to the user.

On the basis of the above embodiments, the acquisition condition is to acquire a voice skill of the same type;

the processing module 602 is configured to:

acquire type information of the first voice skill; and

acquire, according to the acquisition condition, the second voice skill that has the same type information as that of the first voice skill.

On the basis of the above embodiments, the acquisition condition is to acquire a voice skill having the same developer;

the processing module 602 is configured to:

acquire developer information of the first voice skill; and

acquire, according to the acquisition condition, the second voice skill that has the same developer information as that of the first voice skill.

On the basis of the above embodiments, the recommending module 603 is configured to:

acquire user preference information when there are at least two second voice skills; and

determine, according to the user preference information, a target second voice skill from the at least two second voice skills, and recommend the target second voice skill to the user.

On the basis of the above embodiments, the recommending module 603, when acquiring user preference information, is configured to:

acquire, according to a historical behavior log of the user acquired in advance, the user preference information.

On the basis of the above embodiments, the recommending module 603 is configured to:

generate, according to the second voice skill, voice recommendation information, and playing the voice recommendation information; and

enable the second voice skill after receiving a start command for the second voice skill from the user.

On the basis of the above embodiments, the recommending module 603 is further configured to:

display the second voice skill on a display unit; and

receive a selection operation command of the user for the second voice skill on the display unit, and enable the second voice skill according to the selection operation command.

The voice skill recommendation apparatus provided in the embodiment may be specifically configured to execute the method embodiments provided in FIG. 1 and FIGS. 3 to 5, and specific functions will not be repeated herein.

A voice skill recommendation apparatus according to the above embodiment, by acquiring a voice command of a user, where the voice command includes an acquisition condition of a voice skill; acquiring, according to the acquisition condition, a second voice skill related to a first voice skill; where the first voice skill is a currently used voice skill or the voice skill contained in the voice command; recommending the second voice skill to the user, can realize an accurate associated recommendation of a voice skills, thereby enhancing user experience, and improving a promotion effect of the voice skills at the same time.

According to an embodiment of the present application, the present application further provides an electronic device and a readable storage medium.

FIG. 7 is a block diagram of an electronic device for implementing a voice skill recommendation method according to an embodiment of the present application. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital assistants, cellular phones, smartphones, wearable devices and other similar computing apparatuses. Components shown herein, and connections, relationships and functions thereof are intended only as examples and are not intended to limit the implementation of the present application described and/or required herein.

As shown in FIG. 7, the electronic device includes: one or more processors 701, a memory 702, and interfaces for connecting various components, including a high-speed interface and a low-speed interface. The various components are interconnected using different buses and can be mounted on a common mainboard or be mounted otherwise as required. The processor may process instructions executed within the electronic device, including instructions stored in the memory or stored on the memory in the form of an external input/output apparatus such as a display device coupled to an interface to display graphical information of the GUI. In other embodiments, multiple processors and/or multiple buses can be used with multiple memories and multiple memories, if desired. Similarly, multiple electronic devices can be connected, and each device provides some of the necessary operations (for example, as a server array, a group of blade servers, or a multiprocessor system). An example of a processor 701 is shown in FIG. 7.

The memory 702 is a non-transitory computer-readable storage medium provided by the present application. Where the memory stores instructions that can be executed by at least one processor to cause the at least one processor to execute the voice skill recommendation method provided in the present application. The non-transitory computer-readable storage medium of the present application stores computer instructions that are used to cause a computer to execute the voice skill recommendation method provided by the present application.

The memory 702, as a non-transitory computer-readable storage medium, can be configured to store non-transitory software programs, non-transitory computer executable programs, and modules, such as program instructions/modules corresponding to the voice skill recommendation method in the embodiments of the present application (for example, the acquiring module 601, the processing module 602, and the recommending module 603 shown in FIG. 6). The processor 701 performs various functional applications of the server and data processing of the server by running the non-transitory software programs, instructions, and modules stored in the memory 702, that is, implementing the voice skill recommendation method in the above method embodiment.

The memory 702 may include a storage program area and a storage data area, where the storage program area may store an operating system and an application program required for at least one function; the storage data area may store data created based on the use of an electronic device for the voice skill recommendation method. In addition, the memory 702 may include a high-speed random access memory, and may also include a non-transitory memory, such as at least one magnetic disk storage device, a flash memory device, or other non-transitory solid-state storage device. In some embodiments, the memory 702 may include a memory remotely set with respect to the processor 701, and these remote memories may be connected to an electronic device for the voice skill recommendation method through a network. Examples of such networks include, but are not limited to, an Internet, an Intranet, a local area network, a mobile communication network, and combinations thereof.

The electronic device for the voice skill recommendation method may further include: an input apparatus 703 and an output apparatus 704. The processor 701, the memory 702, the input apparatus 703, and the output apparatus 704 may be connected through a bus or by other means. An example of connecting by bus is shown in FIG. 7.

The input apparatus 703 may receive inputted digital or character information and produce key signal inputs related to user settings and function control of the electronic device for the voice skill recommendation method, such as a touch screen, keypad, mouse, track pad, touchpad, pointing stick, one or more mouse buttons, trackball, joystick and other input apparatuses. The output apparatus 704 may include a display device, an auxiliary lighting device (for example, an LED), a haptic feedback apparatus (for example, a vibration motor), etc. The display device may include, but is not limited to, a liquid crystal display (LCD), a light emitting diode (LED) display, and a plasma display. In some embodiments, the display device may be a touch screen.

Various implementations of the systems and technologies described herein can be implemented in a digital electronic circuit system, an integrated circuit system, an ASIC (application-specific integrated circuit), a computer hardware, a firmware, a software, and/or a combination thereof. The various implementations may include: implemented in one or more computer programs that are executable and/or interpreted on a programmable system including at least one programmable processor, the programmable processor may be a dedicated or general-purpose programmable processor, may receive data and instructions from a storage system, at least one input apparatus, and at least one output apparatus, and may transmit the data and instructions to the storage system, the at least one input apparatus, and the at least one output apparatus.

These computing programs (also known as programs, software, software applications, or codes) include machine instructions of a programmable processor and can be implemented using advanced process and/or object-oriented programming languages, and/or assembly languages/machine languages. As used herein, terms “machine-readable medium” and “computer-readable medium” refer to any computer program product, device, and/or apparatus (for example, a magnetic disk, an optical disk, a memory, a programmable logic device (PLD)) that is used to provide machine instructions and/or data to the programmable processor, including machine-readable medium that receive machine instructions as machine-readable signals. The term “machine-readable signal” refers to any signal used to provide machine instructions and/or data to the programmable processor.

To provide interaction with the user, the systems and techniques described herein can be implemented on a computer, and the computer has: a display device (for example, a CRT (cathode ray tube) or an LCD (liquid crystal display) monitor) for displaying information to the user; a keyboard and a pointing apparatus (for example, a mouse or a trackball) through which the user can provide input to the computer. Other kinds of apparatuses can also be used to provide interaction with the user; for example, the feedback provided to the user can be any form of sensory feedback (for example, visual feedback, auditory feedback, or tactile feedback). Input from the user can be received in any form, including acoustic input, voice input, or tactile input.

The systems and techniques described herein can be implemented on a computing system including back-end components (for example, as a data server), or a computing system including middleware components (for example, an application server), or a computing system including front-end components (for example, a user computer with a graphical user interface or a web browser through which the user can interact with the implementation of the systems and technologies described herein), or a computing system including any combination of these back-end components, middleware components, or front-end components. The components of the system can be interconnected through digital data communication (for example, communication network) in any form or medium. Examples of the communication network include a local area network (LAN), a wide area network (WAN), and an Internet.

The computer system may include both a client and a server. The client and the server are generally far from each other and usually interact over a communication network. A client-server relationship is generated by running a computer program having the client-server relationship on a corresponding computer.

The technical solution according to the embodiment of the present application, by acquiring a voice command of a user, where the voice command includes an acquisition condition of a voice skill; acquiring, according to the acquisition condition, a second voice skill related to a first voice skill; where the first voice skill is a currently used voice skill or the voice skill contained in the voice command; recommending the second voice skill to the user; the embodiment of the present application can realize an accurate associated recommendation of a voice skill, thereby enhancing user experience, and improving a promotion effect of the voice skill at the same time.

The present application further provides a computer program including program code, and when the computer runs the computer program, the program code executes the voice skill recommendation method according to the above embodiment.

It should be understood that various forms of processes shown above can be used to reorder, add, or remove steps. For example, the steps described in the present application can be executed in parallel, in sequence, or in different orders, which will not be limited herein provided that the desired results of the technical solution disclosed in the present application are achieved.

The above specific implementations do not constitute a limitation on the protection scope of the present application. It should be understood by those skilled in the art that various modifications, combinations, sub-combinations, and substitutions may be made according to design requirements and other factors. Any modifications, substitutions and improvements made within the spirit and principles of the present application shall be covered by the present application.

What is claimed is:

1. A voice skill recommendation method, comprising:
acquiring a voice command of a user, wherein the voice command comprises an acquisition condition of a voice skill;
acquiring, according to the acquisition condition, a second voice skill related to a first voice skill; wherein the first voice skill is a currently used voice skill or the voice skill contained in the voice command; and
recommending the second voice skill to the user.

2. The method according to claim 1, wherein the acquisition condition is to acquire a voice skill of the same type.

3. The method according to claim 2, wherein the acquiring, according to the acquisition condition, a second voice skill related to a first voice skill, comprises:
acquiring type information of the first voice skill; and
acquiring, according to the acquisition condition, the second voice skill that has the same type information as that of the first voice skill.

4. The method according to claim 1, wherein the acquisition condition is to acquire a voice skill having the same developer.

5. The method according to claim 4, wherein the acquiring, according to the acquisition condition, a second voice skill related to a first voice skill, comprises:
acquiring developer information of the first voice skill; and
acquiring, according to the acquisition condition, the second voice skill that has the same developer information as that of the first voice skill.

6. The method according to claim 1, wherein the recommending the second voice skill to the user, comprises:
acquiring user preference information when there are at least two second voice skills; and
determining, according to the user preference information, a target second voice skill from the at least two second voice skills, and recommending the target second voice skill to the user.

7. The method according to claim 6, wherein the acquiring user preference information, comprises:
acquiring, according to a historical behavior log of the user acquired in advance, the user preference information.

8. The method according to claim 6, wherein recommending the second voice skill to the user, comprises:
generating, according to the second voice skill, voice recommendation information, and playing the voice recommendation information; and
enabling the second voice skill after receiving a start command for the second voice skill from the user.

9. The method according to claim 1, further comprising:
displaying the second voice skill on a display unit; and
receiving a selection operation command of the user for the second voice skill on the display unit, and enabling the second voice skill according to the selection operation command.

10. A voice skill recommendation apparatus, comprising:
at least one processor; and
a memory, communicatively connected to the at least one processor; wherein
the memory stores instructions executable by the at least one processor, and the instructions are executed by the at least one processor to cause the at least one processor to:
acquire a voice command of a user, wherein the voice command comprises an acquisition condition of a voice skill;
acquire, according to the acquisition condition, a second voice skill related to a first voice skill; wherein the first voice skill is a currently used voice skill or the voice skill contained in the voice command; and
recommend the second voice skill to the user.

11. The apparatus according to claim 10, wherein the acquisition condition is to acquire a voice skill of the same type.

12. The apparatus according to claim 11, wherein the instructions are executed by the at least one processor to cause the at least one processor to:
acquire type information of the first voice skill; and
acquire, according to the acquisition condition, the second voice skill that has the same type information as that of the first voice skill.

13. The apparatus according to claim 10, wherein the acquisition condition is to acquire a voice skill having the same developer.

14. The apparatus according to claim 13, wherein the instructions are executed by the at least one processor to cause the at least one processor to:
acquire developer information of the first voice skill; and
acquire, according to the acquisition condition, the second voice skill that has the same developer information as that of the first voice skill.

15. The apparatus according to claim 10, wherein the instructions are executed by the at least one processor to cause the at least one processor to:
acquire user preference information when there are at least two second voice skills; and
determine, according to the user preference information, a target second voice skill from the at least two second voice skills, and recommend the target second voice skill to the user.

16. The apparatus according to claim 15, wherein the instructions are executed by the at least one processor to cause the at least one processor to:
acquire, according to a historical behavior log of the user acquired in advance, the user preference information.

17. The apparatus according to claim 15, wherein the instructions are executed by the at least one processor to cause the at least one processor to:
generate, according to the second voice skill, voice recommendation information, and playing the voice recommendation information; and
enable the second voice skill after receiving a start command for the second voice skill from the user.

18. The apparatus according to claim 10, wherein the instructions are executed by the at least one processor to cause the at least one processor to:
display the second voice skill on a display unit; and
receive a selection operation command of the user for the second voice skill on the display unit, and enable the second voice skill according to the selection operation command.

19. A non-transitory computer-readable storage medium having stored thereon computer instructions, wherein the computer instructions are configured to cause the computer to execute the method according to claim 1.

20. A voice skill recommendation method, comprising:
acquiring an acquisition command for a voice skill of a user;
acquiring, according to the acquisition command for the voice skill, a target voice skill; and
recommending the target voice skill to the user.
